(19) United States
(12) Patent Application Publication
(10) Pub. No.: US 2026/0014646 A1
(43) Pub. Date: Jan. 15, 2026

(54) JET NOZZLE WITH A COOLING SYSTEM

(71) Applicant: TRUMPF Laser- und Systemtechnik SE, Ditzingen (DE)

(72) Inventors: Nicolai SPEKER, Pleidelsheim (DE); Björn SAUTTER, Leonberg (DE); Andreas SCHOLZ, Taunusstein (DE); Stefan BELITZ, Stuttgart (DE); Arne STECK, Remseck am Neckar (DE); Jakob SPIECKER, Stuttgart (DE); Fabian GOETZELMANN, Leonberg (DE); Tim HESSE, Ditzingen (DE); Holger BRAUN, Renningen (DE)

(21) Appl. No.: 19/280,146

(22) Filed: Jul. 25, 2025

Related U.S. Application Data
(63) Continuation of application No. PCT/EP2024/051298, filed on Jan. 19, 2024.

(30) Foreign Application Priority Data
Jan. 27, 2023 (DE) 10 2023 102 043.9
Sep. 4, 2023 (DE) 10 2023 123 705.5

(51) Int. Cl. B23K 26/14; B33Y 80/00

(52) U.S. Cl. CPC B23K 26/1476; B33Y 80/00

(57) ABSTRACT

A jet nozzle for laser deposition welding along a feed direction includes a light channel for guiding at least one laser beam that is directed onto a workpiece, and an outer structure that surrounds the light channel at least in sections and extends from a flange portion to a distal region, which is formed by a nozzle mouth and from which the laser beam emerges. The outer structure includes a cooling system, which has a radially inner cooling chamber at least in sections and a radially outer cooling chamber at least in sections, through which a coolant flows.

### CROSS REFERENCE TO RELATED APPLICATIONS

This application is a continuation of International Application No. PCT/EP2024/051298 (WO 2024/156617 A1), filed on Jan. 19, 2024, and claims benefit to German Patent Application No. DE 10 2023 123 705.5, filed on Sep. 4, 2023 and to German Patent Application No. DE 10 2023 102 043.9, filed on Jan. 27, 2023. The aforementioned applications are hereby incorporated by reference herein.

### FIELD

Embodiments of the present invention relate to a jet nozzle for laser deposition welding along a feed direction.

### BACKGROUND

Laser deposition welding is used in the fields of repair, coating, and/or joining technology, for example. A distinction can be made between conventional laser deposition welding techniques (laser metal deposition (LMD), direct metal deposition (DMD) or direct energy deposition (DED)), and high-speed laser deposition welding (HS-LMD) or extreme high-speed laser application (EHLA)). HS-LMD methods are described, for example, in the disclosure documents DE 10 2011 100 456 A and DE 10 2018 130 798 A1. Another method for laser deposition welding is known from the Chinese patent application CN 109175372 A. A powder nozzle for a laser processing machine is known from the published patent application DE 10 2017 215841 A1.

A functional layer can be applied onto a workpiece by means of laser deposition welding. This generally increases the load capacity of the workpiece processed by means of laser deposition welding compared to an unprocessed workpiece. The functional layer can serve as a wear protection layer, for example. The application of the functional layer is based on a melting of a workpiece surface, an application of a powdered filler material, and a subsequent cooling so that a matrix structure with hard material particles is materially bonded to the material surface. Laser deposition welding therefore engages with the inner material structure of the workpiece and changes it. Under certain circumstances, this can result in imperfections in the internal material structure. These can impair the desired increase in load capacity. The imperfections can be of a microscopic nature, which is why they can only be identified with great effort.

### SUMMARY

Embodiments of the present invention provide a jet nozzle for laser deposition welding along a feed direction. The jet nozzle includes a light channel for guiding at least one laser beam that is directed onto a workpiece, and an outer structure that surrounds the light channel at least in sections and extends from a flange portion to a distal region, which is formed by a nozzle mouth and from which the laser beam emerges. The outer structure includes a cooling system, which has a radially inner cooling chamber at least in sections and a radially outer cooling chamber at least in sections, through which a coolant flows.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser deposition welding according to some embodiments;

FIG. 2 shows a side view of a jet nozzle according to some embodiments;

FIG. 3 shows a perspective view of the jet nozzle from FIG. 2 according to some embodiments;

FIG. 4 shows the jet nozzle from FIG. 2 connected to other components according to some embodiments;

FIG. 5 shows a top view of a distal region of the jet nozzle from FIG. 2 according to some embodiments;

FIG. 6 shows a top view of a flange portion of the jet nozzle from FIG. 2 according to some embodiments;

FIG. 7 shows another perspective view of the jet nozzle from FIG. 2 according to some embodiments;

FIG. 8 shows a perspective sectional view of the jet nozzle from FIG. 2 according to some embodiments;

FIG. 9 shows another perspective sectional view of the jet nozzle from FIG. 2 according to some embodiments;

FIG. 10 shows different views of a cooling system with a pin structure according to some embodiments;

FIG. 11 shows the jet nozzle with a process gas unit in a top view of the distal region according to some embodiments;

FIG. 12 shows a further embodiment of the jet nozzle with a geometrically adapted nozzle mouth in a side view; and

FIG. 13 shows a further embodiment of the jet nozzle with a geometrically adapted nozzle mouth in a top view.

### DETAILED DESCRIPTION

Embodiments of the present invention provide an improved jet nozzle for laser deposition welding along a feed direction. Embodiments of the invention can increase the welding quality of an applied functional layer and of the workpiece as a whole, and to reduce or avoid imperfections in a welded joint between a powdered filler material and a material surface. The imperfections can be in the form of a lack of fusion between the material surface and the applied functional layer or between individual applied functional layers. The imperfections can also be pores, i.e., air pockets, which occur within the applied functional layer, or between the applied functional layer and the material surface. Particularly if the material surface is a cast material, pores can occur more frequently. The imperfections can also be cracks that run vertically to the material surface within the applied functional layer. The imperfections can also result from the fact that powder particles, in particular carbides, of the powdered filler material dissolve in a matrix material of the powdered filler material, which leads to a brittleness of the matrix material. Embodiments of the invention can provide a reliable jet nozzle that is resistant to thermal loads. Embodiments of the invention can also provide the jet nozzle in such a way that it ensures reliable and precise laser deposition welding over a very high number of cycles.

Accordingly, a jet nozzle for laser deposition welding along a feed direction is provided, which comprises a light channel for conducting at least one laser beam, which is directed onto a workpiece. Laser deposition welding can be a method for high-speed laser metal deposition (HS-LMD). The feed direction is the direction along which the jet nozzle moves relative to the workpiece. It can result from a movement, in particular a rotational movement, of the workpiece, from a movement of the jet nozzle, or from an overlay of both movements. The feed direction and the correlating feed motion can be constant over the course of the process. Alternatively, they can vary with the respective process stage. The workpiece can be a rotationally symmetrical workpiece, such as a brake disk, a hydraulic cylinder, a pressure roller, or a plain bearing. The laser beam can shine through the light channel. It can be provided by a laser source, from which the laser beam is guided by means of an optical fiber cable to a laser system that splits the laser beam via a collimator lens and focuses it in line with the process via laser optics before it enters the jet nozzle. The light channel can be a hollow channel that runs through the entire jet nozzle along a longitudinal direction. In addition to the laser beam, a process gas can also be directed to the workpiece surface through the light channel.

The jet nozzle further has an outer structure, which surrounds the light channel at least in sections and extends from a flange portion to a distal region, which is formed by a nozzle mouth and from which the laser beam emerges. The outer structure can have a powder unit. The powder unit can be part of the nozzle mouth. The nozzle mouth is the part of the jet nozzle facing the workpiece. The end portion of the nozzle mouth forms the distal region. This is the part of the nozzle mouth that is closest to the workpiece. On the section facing away from the workpiece, the jet nozzle has a proximal region and the flange portion. The proximal region and the flange portion are the part of the jet nozzle facing away from the workpiece. The nozzle can be coupled to another component of the laser system, such as laser optics or a process unit, via the flange portion. The outer structure can be a component made of a uniform material and can have a hollow channel along its longitudinal direction which represents the light channel.

The outer structure comprises a cooling system, which has a radially inner cooling chamber at least in sections and a radially outer cooling chamber at least in section, which are intended to be flowed through by a coolant, in particular water. The cooling system enables efficient heat management of the jet nozzle. Due to the thermal energy input of the laser beam and the powder jet, the jet nozzle is exposed to very high thermal loads. Added to this is the reflected radiation from the workpiece. The cooling system helps the jet nozzle to withstand this high thermal load. The radially inner cooling chamber faces the light channel; the radially outer cooling chamber faces the environment. The radially inner cooling chamber can run concentrically to the light channel, at least in sections. Likewise, the radially outer cooling chamber can run concentrically to the light channel, at least in sections. The coolant is supplied to and removed from the outer structure in a stationary manner so that heat is continuously dissipated.

The jet nozzle can thus provide increased variability in (i) laser beam guidance, (ii) the use of a powdered filler material, (iii) heat management, and/or (iv) protection of the laser system including the jet nozzle. It enables the provision of several independent process zones with high precision. The process zones can be divided into zones for laser deposition welding and zones for pre-processing and/or post-processing. In the zones for laser deposition welding, an interaction takes place between at least one laser beam and a powdered filler material. The pre-processing and/or post-processing can be the cleaning of the material surface, the pre-heating of the material surface before the powdered filler material is applied, the post-heating of the material surface after the powdered filler material has been applied, or a combination thereof. During pre-processing and/or post-processing, the laser beam can strike the workpiece without interacting with the powdered filler material. The independent process zones can increase the welding quality and thus the load capacity of the applied functional layer, in particular the wear protection layer, and of the workpiece as a whole. An additional process gas can stabilize the process zones and increase the precision of laser deposition welding as well as the service life of the jet nozzle.

In particular, the jet nozzle can reduce the occurrence of any lack of fusion. This is because lack of fusion can occur if the surface heated by the laser beam, such as when the workpiece or a previously welded-on functional layer, has not been sufficiently heated. This lack of heating can be the result of the laser power of a single laser beam being kept low to avoid overheating the powdered filler material. Due to the increased variability of the laser beam guidance, the increased variability of the application of a powdered filler material and/or the increased variability of the heat management of the jet nozzle, the occurrence of a lack of fusion can be reduced or even avoided, in particular by the jet nozzle having a cooling system that ensures efficient cooling by means of the radially inner and radially outer cooling chamber, which can also cool several process zones.

In particular, the jet nozzle can also reduce the occurrence of pores between the welded-on functional layer and the surface heated by the laser beam. This is because pores can occur when lamellae in the workpiece, in particular graphite lamellae, are vaporized by the laser radiation. Pores can also occur if the surface to be machined has impurities, for example caused by oils, greases, cooling lubricants or oxides, which cannot be completely removed by the welding process. The undesired vaporization of the impurities can be the result of the laser power of a single laser beam being set so high that a lack of fusion due to insufficient heating can be avoided. Due to the increased variability of the laser beam guidance, the increased variability of the application of a powdered filler material and/or the increased variability of the heat management of the jet nozzle, the occurrence of pores can be reduced or even avoided, in particular by the jet nozzle having a cooling system that ensures efficient cooling by means of the radially inner and radially outer cooling chamber, which can also cool several process zones.

In particular, the jet nozzle can also reduce the occurrence of cracks in the welded-on functional layer. This is because cracks can occur if a temperature gradient between the strongly heated powdered filler material and the less strongly heated workpiece surface is so strong that the material shrinkage that occurs during cooling results in stresses that cause cracks. Cracking can be the result of a laser power of a single laser beam being set so high that a lack of fusion due to insufficient heating can be avoided. Due to the increased variability of the laser beam guidance, the increased variability of the application of a powdered filler material and/or the increased variability of the heat management of the jet nozzle, the occurrence of cracks can be reduced or even avoided, in particular by the jet nozzle having a cooling system that ensures efficient cooling by means of the radially inner and radially outer cooling chamber, which can also cool several process zones.

In particular, the jet nozzle can also reduce the dissolution of hard material particles, in particular carbides, in the matrix material. The powdered filler material can contain hard material particles, in particular carbides, and a matrix material. The hard material particles should be present undissolved in the welded-on functional layer to increase the load capacity of the functional layer. However, hard material particles can dissolve if the powdered filler material is exposed to too high a radiation level, causing the hard material particles to melt. Dissolved hard material particles cause the welded-on functional layer to become brittle because the matrix material is less ductile, which means that stresses caused by shrinkage, for example, cannot be absorbed by the matrix material when the workpiece is cooled or loaded. Due to the increased variability of the laser beam guidance, the increased variability of the application of a powdered filler material and/or the increased variability of the heat management of the jet nozzle, the dissolving of hard material particles can be reduced or even avoided, in particular by the jet nozzle having a cooling system that ensures efficient cooling by means of the radially inner and radially outer cooling chamber, which can also cool several process zones.

In particular, the jet nozzle can prevent an adhesion of powder particles to the nozzle mouth. In principle, high process heat, reflective laser radiation, and/or a metal vapor plume can cause an adhering or even welding of filler material to the nozzle mouth, which can disrupt the gas and powder flows and subsequently impair the process result. The metal vapor plume is a result of the partial vaporization of the material due to the laser deposition welding. It can lead to scattering and/or absorption of laser radiation and consequently impair the preheating of the workpiece. This can further promote the formation of a lack of fusion. Due to the increased variability of the laser beam guidance, the increased variability of the application of a powdered filler material and/or the increased variability of the heat management of the jet nozzle, undesired dissolving of hard material particles as well as the propagation of the metal vapor plume can be reduced or even avoided, in particular by the jet nozzle having a cooling system that ensures efficient cooling by means of the radially inner and radially outer cooling chamber, which can also cool several process zones.

The cooling system with its division into radially inner and radially outer cooling chambers enables a uniform flow distribution along the circumference of the nozzle mouth. The flow can be turbulent. The radially inner cooling chamber and the radially outer cooling chamber are designed in such a way that they result in a very low pressure loss, for example below 0.15 bar. The nozzle mouth is efficiently cooled by the cooling system. This prevents the individual injector guides from welding together due to excessive heat generation in the area of the nozzle mouth. The heat in the region of the nozzle mouth can primarily be attributed to the thermal energy of the laser beam and the powdered filler material. The heat can also be due to radiation reflected from the workpiece back to the jet nozzle. The heat is reliably dissipated by the cooling system. The improved properties of the jet nozzle due to the cooling system enable welding behavior without the aforementioned imperfections.

In one embodiment, the radially outer cooling chamber extends from the distal region to a proximal region which adjoins the flange portion. The radially outer cooling chamber can thus extend over the entire height of the jet nozzle, with the exception of the flange portion. Accordingly, energy is transferred from the jet nozzle to the cooling medium over the entire height of the jet nozzle, which contributes to efficient heat management.

In one embodiment, the radially inner cooling chamber is formed at least in the nozzle mouth and extends in particular from the distal region to a proximal region which adjoins the flange portion. This enables efficient cooling of the nozzle mouth. The radially inner cooling chamber can thus extend over the entire height of the jet nozzle, with the exception of the flange portion. Accordingly, energy is transferred from the jet nozzle to the cooling medium over the entire height of the jet nozzle, which contributes to efficient heat management. The radially inner cooling chamber may have a bead in the proximal region that differs from an annular gap shape, which promotes the inflow properties from the heat inlet into the entire radially inner cooling chamber.

In one embodiment, the radially inner cooling chamber runs concentrically to the light channel in a cross-sectional area orthogonal to a longitudinal direction of the jet nozzle. In particular, the radially inner cooling chamber runs concentrically to the light channel over its entire height.

In one embodiment, the radially inner cooling chamber is a channel running in a circumferential direction at least in the region of the nozzle mouth. In particular, the cooling chamber is a circumferential channel from the nozzle mouth to the proximal region. Thus, the thermal energy supplied to the jet nozzle can be dissipated over a large area.

In one embodiment, the radially inner cooling chamber and/or the radially outer cooling chamber comprises a cooling structure for increasing the surface area. The cooling structure, like the remaining jet nozzle, can be manufactured using an additive manufacturing process. It ensures that the cooling medium comes into contact with as much surface area as possible during the supply and/or return from the distal region to the proximal region to promote heat dissipation. The cooling structure is optimized to minimize pressure losses of the cooling medium. This is ensured by a uniform, in particular turbulent flow distribution around the circumference of the nozzle mouth. Since the nozzle mouth is the primary region of heat generation, the efficient heat dissipation from the nozzle mouth thus ensured is particularly useful.

In one embodiment, the cooling structure is designed in the manner of a honeycomb structure and/or in the manner of a pin structure and/or in the manner of a fin structure. The honeycomb structure can have a plurality of honeycombs. The individual honeycombs are arranged relative to each other in such a way that the cooling medium is exposed to a substantially constant passage area. The honeycomb structure can adapt to the geometric conditions of the jet nozzle along the circumferential direction. For example, if a powder portion is provided in the nozzle mouth, the honeycombs may have a different shape than if a powder-free feed portion is provided. The pin contour can be composed of individual pins, which in particular have a circular cross-section. This can ensure an optimal surface ratio for optimal heat dissipation. The fin structure may be composed of individual fins, which in particular have an oval and/or almond-shaped and/or drop-shaped cross-section. This can ensure a flow-optimized surface for low pressure losses.

In one embodiment, a transition is provided from the radially inner cooling chamber to the radially outer cooling chamber in the distal region. This ensures that the cooling medium flows through the radially inner cooling chamber to the distal area until it merges into the radially outer cooling chamber. The transition can be annular in the distal area.

In one embodiment, in the outer structure, a powder unit arranged radially outside the light channel is formed for guiding at least one powder jet which is to be applied to the workpiece, wherein the powder unit forms a powder portion at the nozzle mouth in a circumferential direction around the light channel, to which a powder unit-free feed portion adjoins in the circumferential direction. The feed portion can be the portion which faces the feed direction, i.e., points in the direction of the feed direction. The feed portion can extend along the circumferential direction around the light channel in an angular range. The region in which the feed portion is formed can correlate with the position and orientation of the powder injectors which apply the powdered filler material to the workpiece. The powder portion and the feed portion can together form the entire circumference of the nozzle mouth around the light channel. For example, the powder portion can make up the larger part than the feed portion. In the plan view, the powder portion and the feed portion can run closed along an opening of the light channel; for example, an elongated opening.

In one embodiment, the transition from the radially inner cooling chamber to the radially outer cooling chamber is designed as a passage in the feed portion. The passage may be the only transition from the radially inner cooling chamber to the radially outer cooling chamber. Thus, the cooling medium is guided in such a way that it is guided from the annular structure of the radially inner cooling chamber to the local passage before being guided into the outer cooling chamber, which also extends along the entire circumferential direction. This further contributes to efficient heat management.

In one embodiment, the radially inner cooling chamber is connected to a coolant inflow and the radially outer chamber is connected to a coolant discharge. In this case, a coolant inlet to the coolant inflow can be arranged in the proximal region and/or a coolant outlet from the coolant drainage can be arranged in the proximal region. After the coolant inlet, the cooled medium is thus guided into the radially inner cooling chamber before it reaches the radially outer cooling chamber as an already heated cooling medium. This allows the nozzle head to be cooled particularly efficiently.

In one embodiment, the coolant inlet and/or the coolant outlet protrude at least partially radially from the outer structure. They can also form an angle relative to each other. On the one hand, this provides the axial installation space required by the jet nozzle, and on the other hand, also allows the cooling medium to be swirled in a targeted manner thanks to the radial flow. In this way, the variability of heat management can be further taken into account.

In one embodiment, the jet nozzle is manufactured by means of an additive manufacturing process, in particular by means of powder bed fusion. For this purpose, the jet nozzle can be made of copper or a copper alloy, further in particular a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example.

In one embodiment, the nozzle mouth comprises a chamfer, by means of which a part of the nozzle mouth is cut off, wherein the chamfer is substantially planar and runs in a plane which is inclined relative to the longitudinal direction of the jet nozzle. The chamfer can cut off the powder portion and the powder portion-free feed portion in the circumferential direction around the light channel. The chamfer reduces the volume of the nozzle mouth compared to the embodiment in which no chamfer is provided. This means that the nozzle mouth takes up less installation space. The jet nozzle with the chamfer can be used, for example, to coat a brake disk that has a mount that protrudes axially from the functional surface to be coated. The chamfer ensures that the jet nozzle can move flexibly on the functional surface to be coated and can be moved close to the mount. The chamfer can run in the distal region like a passant on the elongated hole. The passant defines the orientation of the chamfer on the nozzle mouth. In the end face of the jet nozzle facing the workpiece, the passant runs along a straight line or an arc that neither intersects nor touches the elongated hole. The distance of the passant from the center point of the light channel is greater than the distance of the corresponding section of the elongated hole from the center point of the light channel. The distance between the passant and an outer edge of the elongated hole is selected in such a way that the wall thickness therebetween ensures sufficient sturdiness and load capacity of the jet nozzle.

In one embodiment, the jet nozzle is adapted to guide the laser beam along the longitudinal direction of the jet nozzle, so that the at least one laser beam is orthogonal to the cross-sectional area. Furthermore, the light channel can be adapted to guide a shielding gas along a radially outer portion to shield a process zone.

The features according to the disclosure contribute partly on their own and partly in combination to overcoming the imperfections of laser deposition welding mentioned at the outset.

Exemplary embodiments are described below with reference to the figures. In this case, elements that are the same, similar, or have the same effect are provided with identical reference symbols in the different figures, and a repeated description of these elements is omitted in some instances to avoid redundancies.

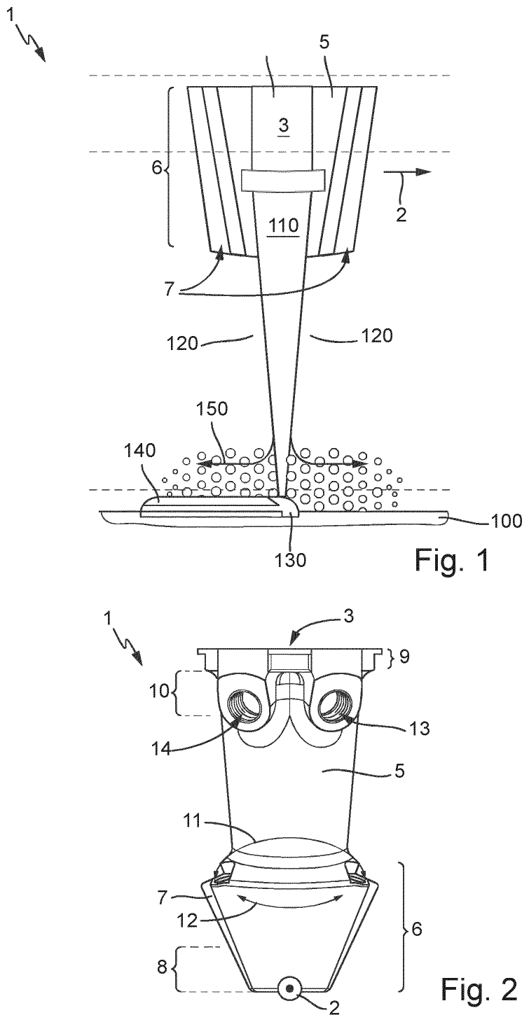

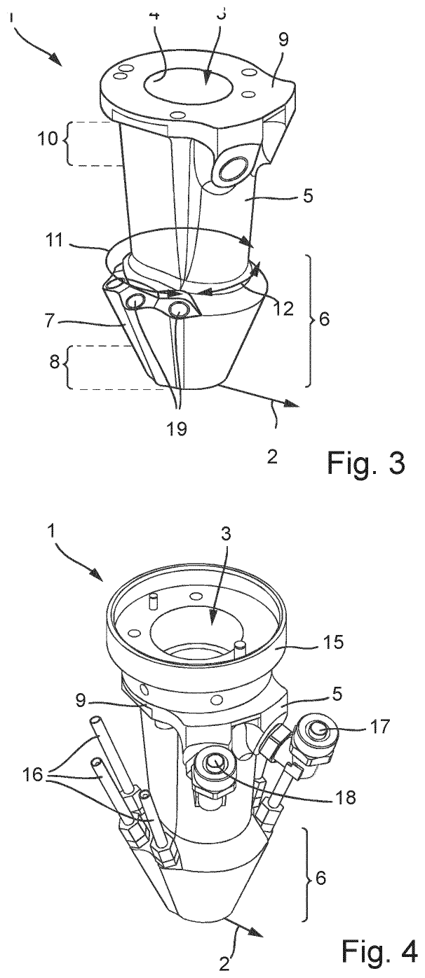

FIG. 1 shows a jet nozzle 1 for laser deposition welding along a feed direction 2. The feed direction 2 is the direction along which the jet nozzle 1 moves relative to a workpiece 100. It can result from a movement, in particular a rotational movement, of the workpiece 100, from a movement of the jet nozzle 1 or from an overlay of a movement of the workpiece 100 and the jet nozzle 1. The feed direction 2 and the correlating feed motion can be constant over the course of the process. Alternatively, they can vary with the respective process stage. The workpiece 100 can be a rotationally symmetrical workpiece, such as a brake disk, a hydraulic cylinder, a pressure roller, or a plain bearing. At least one laser beam 110 emerges from a light channel 3 with a lateral surface 4. The light channel 3 can also be adapted to guide a process shielding gas 150 along a radially outer portion for shielding a process zone and preventing oxidation. The light channel 3 is surrounded by an outer structure 5, which has a nozzle mouth 6, which in turn contains a powder unit 7. The powder unit 7 can, for example, have a plurality of injector guides 19 (see FIG. 3), into each of which can be inserted a powder injector 16 (see FIG. 4). As an alternative to the individual injector guides 19, the powder unit 7 can have a powder ring gap channel. A powdered filler material 120 is directed onto the workpiece 100 via the powder unit 7 and the powder injectors 16 arranged therein. The laser beam 110 heats the workpiece 100 in such a way that a weld pool 130 forms on a material surface. In addition, the laser beam 110 heats the powdered filler material 120, which comprises hard material particles and a matrix material. For this purpose, the laser beam 110 can have a reduced core intensity. As soon as the weld pool 130 cools down, a welded-on functional layer 140, for example a wear protection layer, is formed from the hard material particles and the matrix material. The welded-on functional layer 140 makes the material surface more resistant and increases its load capacity.

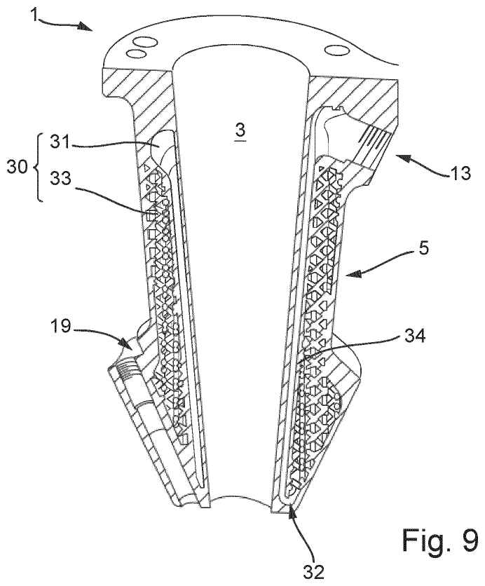

FIG. 2 shows the jet nozzle 1 in a side view, with the feed direction 2 pointing out of the drawing plane. The jet nozzle 1 can be coupled to other components of a laser system, such as the laser optics or a process adapter, via a flange portion 9. A proximal region 10 is attached to the flange portion 9. A coolant inlet 13 and a coolant outlet 14, which are part of a cooling system of the jet nozzle 1 and which project radially from the jet nozzle 1, can be provided at least partially in the proximal region 10. A distal region 8 is formed at the end of the jet nozzle 1 opposite the proximal region 10. The distal region is part of the funnel-shaped nozzle mouth 6. In a circumferential direction around the light channel 3, this has a powder portion 11 in sections, in which the powder unit 7 is arranged. The powder portion 11 is followed in the circumferential direction by a powder unit-free feed portion 12. The feed portion 12 can be designed as a process gas portion 61 (see, for example, FIG. 9), which is part of a process gas unit 60.

FIG. 3 shows a perspective view of the jet nozzle from FIG. 2. The light channel 3 is a hollow channel with a lateral surface 4, within which runs the at least one laser beam 110. The outer structure 5 surrounds the light channel 3 from the flange portion 9 to the distal region 10. The nozzle mouth 6 is a substantially funnel-shaped region of the jet nozzle 1. The funnel shape of the nozzle mouth 6 serves, among other things, to enable the nozzle mouth 6 to form the plurality of injector guides 19 in the region of the powder unit 7. A powder injector 16 (see FIG. 4) is inserted into each of these injector guides 19, which directs the powdered filler material 120 onto the at least one laser beam 110 and/or the workpiece 100 in accordance with the process. The powder unit 7 extends along the powder portion 11, which is followed in the circumferential direction by the powder unit-free feed portion 12. The feed portion 12 is the region of the nozzle mouth 6 in which no injector guides 19 are provided, so that no powdered filler material 120 is supplied via this portion. In one embodiment, the feed portion 12 can be shaped as a process gas portion 61, so that a process gas is supplied via this. The jet nozzle 1 can be manufactured by means of additive manufacturing processes, in particular by means of powder bed fusion. For this purpose, the jet nozzle 1 can be made of a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example.

FIG. 4 shows the jet nozzle 1, to which additional components are attached. A coupling ring 15 is connected to the flange portion 9, which attaches the jet nozzle 1 to the connected unit, for example the laser optics or the process adapter. Powder injectors 16 are inserted into the injector guides 19 of the powder unit 7. The powdered filler material 120 is conveyed by means of the powder injectors 16 and applied to the workpiece 100 with the provided focus. The individual powder injectors 16 can use different powder foci relative to each other. Alternatively, the powder injectors 16 can be directed to the same focus point. The powder injectors 16 are arranged in the provided injector guides 19 of the powder unit 7 in the powder portion 11. The feed portion 12 is free of powder injectors 16. An inlet connection 17 is also inserted into the coolant inlet 13 and an outlet connection 18 is inserted into the coolant outlet 14. These connect the coolant inlet 13 and the coolant outlet 14 to a coolant circuit.

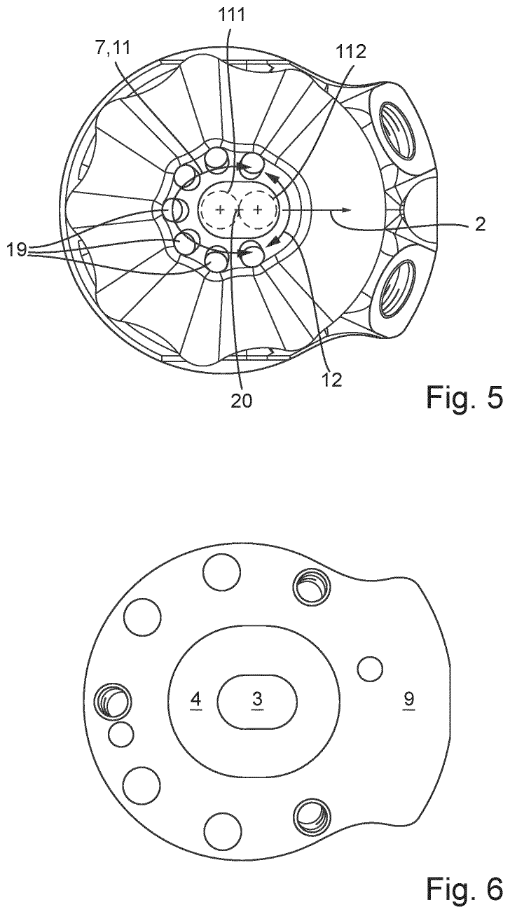

FIG. 5 shows the jet nozzle 1 in a top view of the distal region 8. The cross-sectional area of the light channel 3, which is orthogonal to the longitudinal direction of the jet nozzle 1, deviates from a circular shape and is stretched in the feed direction 2. In the distal region 8, the cross-sectional area of the light channel 3 is designed in the form of an elongated hole, in which two opposite ends of a rectangular section are each joined by a partial circular section. Two laser beams are guided within the light channel 3, a primary beam 111 and a secondary beam 112. The primary beam 111 and the secondary beam 112 can originate from the same optical fiber cable. The laser light provided can be split into a parallel beam bundle via a collimator lens. The beam bundle can, for example, form the primary beam 111 and the secondary beam 112 from a single laser beam using a wedge plate. The respective center points of the primary beam 111 and the secondary beam 112 lie in the feed direction 2 in a line offset to a center point 20 of the light channel 3.

In the present case, the secondary beam 112 lies in front of the primary beam 111 in the feed direction 2 and does not interact with a powder caustic. The secondary beam 112 can thus be used to preheat the workpiece 100 before the primary beam 111 and the powdered filler material 120 heated by the primary beam 111 strike the workpiece 100. The secondary beam 112 thus creates a first process zone, which serves to preheat the workpiece 100, and the primary beam 111 creates a second process zone, which serves to weld the powdered filler material 120 onto the workpiece 100. These different process zones enable a flawless weld in which no imperfections occur, in particular no lack of fusion, no pores, no cracks and/or no dissolution of carbides in the matrix material. It is also possible to guide the secondary beam 112 in the feed direction 2 after the primary beam 111. Thus, the secondary beam 112 can be used to reheat the workpiece 100, contributing to a more uniform cooling that prevents the occurrence of entrapment or other imperfections.

The primary beam 111 and the secondary beam 112 are arranged in close proximity to each other. The front partial circular section of the elongated hole in the feed direction 2 is concentric to the secondary beam 112, while the rear partial circular section of the elongated hole is concentric to the primary beam 111. A area center point of the cross-sectional area is eccentric to a center point of the primary beam 111 and to a center point of the secondary beam 112. A tertiary beam can also be provided so that, for example, the secondary beam is arranged before the primary beam in the feed direction and the tertiary beam is arranged after the primary beam in the feed direction. The individual laser beams are guided to each other without shielding, so that there is exactly one light channel 3 with exactly one lateral surface 4, which results in minimal thermal losses.

Because the primary beam 111 in FIG. 5 is arranged behind the secondary beam 112 in the feed direction 2 without radial offset and the secondary beam 112 serves to preheat the workpiece, it is desirable that the powdered filler material does not interact with the secondary beam 112. This ensures that, on the one hand, the secondary beam 112 can only perform the function of preheating the workpiece and, on the other hand, the powdered filler material is only heated by the primary beam 111 and not by the secondary beam 112. This is achieved by the jet nozzle 1 shaping the powder unit 7 in the region of the nozzle mouth 6 in such a way that it forms the powder portion 11 in the circumferential direction around the light channel 3, to which the powder unit-free feed portion 12 is connected in the circumferential direction. In addition to the powder unit 7, the process gas unit 60 can also be formed, which forms the process gas portion 61, in which case the feed portion 12 is formed as the process gas portion 61. The feed portion 12 is formed in a region of the nozzle mouth 6 facing the feed direction 2. The powder portion 11 extends along the elongated hole that forms the cross-sectional area of the light channel 3 in the distal region 8. Similar to a circular arc, the powder portion 11 extends along an elongated hole arc, in particular in the shape of a horseshoe, around the light channel 3. The powder portion 11 therefore extends in the circumferential direction around the light channel 3 by a wrap angle of less than 360°, in particular between 90° and 330°, further in particular between 180° and 300°, relative to a center point of the light channel. This ensures that the powdered filler material flowing out of the injectors 16, which are inserted in the injector guides 19, only interacts with the primary beam 111. The secondary beam 112 can thus form a process zone independent of the primary beam 111. The powder portion 11 and the feed portion 12 form an elongated hole shape when viewed from above. This also helps to reduce or avoid the imperfections identified at the outset.

FIG. 6 shows the jet nozzle 1 in a top view of the flange portion 9. The cross-sectional area of the light channel 3, which is orthogonal to the longitudinal direction of the jet nozzle 1, also deviates from a circular shape in the region of the flange portion 9 and is stretched in the feed direction 2. The elongation of the cross-sectional area can decrease from the distal region 8 to the flange portion 9. In the region of the nozzle mouth 6, the cross-sectional area can be stretched in such a way that it is at least 1.5 times larger in the feed direction, in particular at least twice as large as transverse to the feed direction. The flange portion 9 has such a radial extension that the injector guides 19 are not visible from the top view of the proximal region 10.

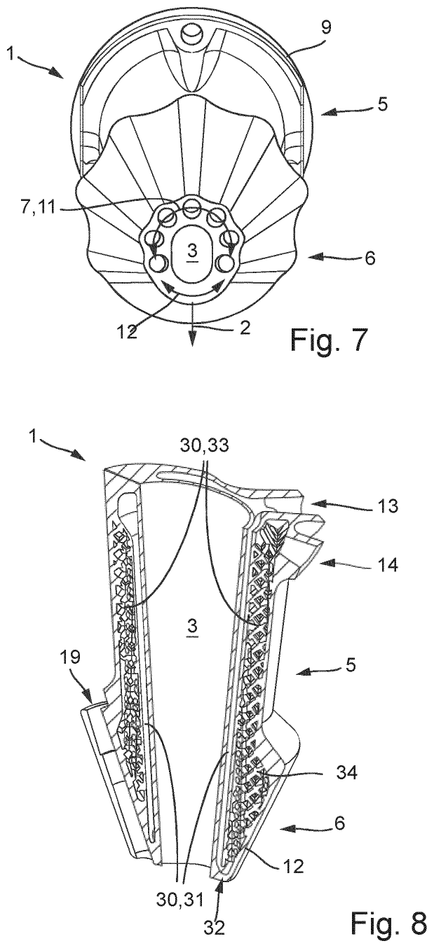

FIG. 7 shows the jet nozzle 1 in a further perspective view. The nozzle mouth 6 has a curved funnel shape. The injector guides 19, into which the powder injectors 16 can be inserted, are formed within the individual curvatures. In the feed direction 2, the light channel is stretched in a way that deviates from a circular shape to achieve the advantages according to the disclosure. In the circumferential direction around the light channel 3, the nozzle mouth 6 has the powder unit 7. This extends in the circumferential direction around the light channel 3 along the powder portion 11, which is adjoined by the powder-free feed portion 12.

FIG. 8 shows a perspective sectional view of the jet nozzle 1. The light channel 3 has a conical shape, so that the cross-sectional area of the light channel 3 running orthogonal to the longitudinal direction of the jet nozzle 1 is smaller in the distal region 8 than in the proximal region 10. The coolant inlet 13 and the coolant outlet 14 are arranged in the proximal region 10 of the jet nozzle 1 and protrude in the radial direction from the jet nozzle 1. FIG. 8 shows a sectional view of an injector guide 19. This is arranged in the powder portion 11. No injector guide 19 for guidance of the jet of powder is provided in the feed portion 12. The jet nozzle 1 has a cooling system 30. A cooling medium, for example water, is fed back to a radially inner cooling chamber 31 via the coolant inlet 13 in the proximal region 10. The cooling medium can be distributed in the proximal region 10 in the circumferential direction around the light channel 3. The cooling medium runs from the proximal region 10 to the nozzle mouth 6. The radially inner cooling chamber 31 is formed at least in the nozzle mouth 6. It can run from the distal region 8 to the proximal region 10 and be designed in the form of an annular gap segment that extends around light channel 3. In the region of the nozzle mouth 6, the radially inner cooling chamber 31 extends circumferentially about the light channel 3. The radially inner cooling chamber 31 has a constant width in the radial direction in the region of the nozzle mouth 6 and is concentric to the light channel 3 in a cross-sectional area running orthogonally to a longitudinal direction of the jet nozzle 1.

A transition 32 between the radially inner cooling chamber 31 and a radially outer cooling chamber 33 is provided in the distal region 8. The radially outer cooling chamber 33 has a radial width that decreases towards the distal region 8 in the radial direction in the region of the nozzle mouth 6. The radially outer cooling chamber 33 extends from the distal region 8 to the proximal region 10, where it feeds the heated coolant to the coolant outlet 14. The transition 32 between the radially inner cooling chamber 31 and the radially outer cooling chamber 33 is arranged in the feed portion 12. The feed portion 12 has no injector guides 19 for guidance of the jet of powder beam, which means that there is sufficient installation space for the transition 32.

The radially outer cooling chamber 33 has a cooling structure to increase the surface area. The cooling structure can be produced by means of an additive manufacturing process. It ensures that the cooling medium comes into contact with as much surface area as possible when returning from the distal region 8 to the proximal region 10 to promote heat dissipation. The cooling structure is optimized to minimize pressure losses of the cooling medium. This can be achieved by a honeycomb structure 34, as shown in FIG. 8.

FIG. 9 shows the jet nozzle 1 in a further perspective sectional view. The coolant inlet 13 is provided in the proximal region 10, which adjoins the flange portion 9. The radially inner cooling chamber 31 extends from the coolant inlet 13 in an annular shape along the circumferential direction around the light channel 3. A proximal portion of the radially inner cooling chamber 31 has a bead, from which the radially inner cooling chamber 31 extends to the distal region 8 with a small radial width relative to the radially outer cooling chamber 33. At the distal transition 32 provided, the cooling medium passes from the radially inner cooling chamber 31 into the radially outer cooling chamber 3. The cooling medium travels a path in the radially outer cooling chamber from the transition 32 to the coolant outlet 14 provided in the proximal region 10. Because the cooling medium is guided from the proximal coolant inlet 13 to the distal transition 32 and further to the proximal coolant outlet 14, a high heat exchange is ensured. This is further increased by the fact that the radially outer cooling chamber 33 has the increased surface area.

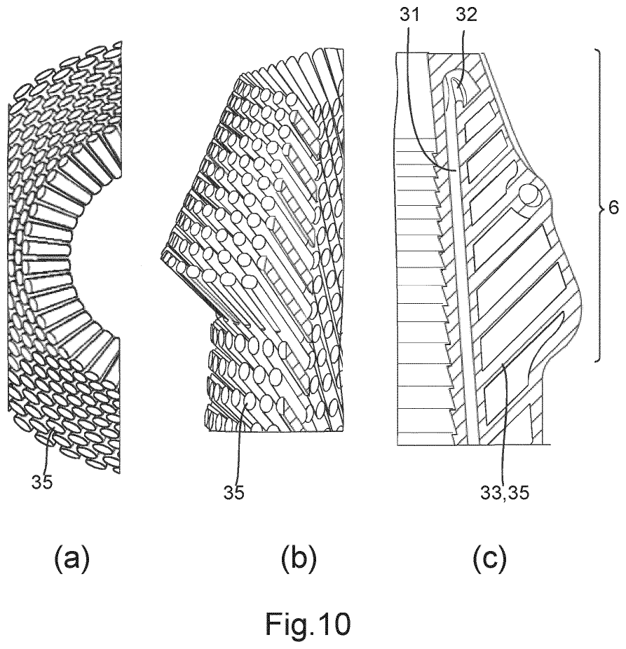

FIGS. 10a, 10b, 10c show an alternative cooling structure to the honeycomb structure 34 in the form of a pin structure 35. This has a plurality of pins. The pins protrude from the surface of the radially outer cooling chamber 33. They can be manufactured using additive manufacturing processes. The individual pins may have a conical cross-section in the radial direction in order to ensure a substantially constant passage area for the cooling medium when flowing through the radially outer cooling chamber 33. This minimizes pressure losses and increases heat exchange. In consecutive rows, the individual pins are offset from each other, which increases forced convection. The density of the pins increases towards the distal region 10.

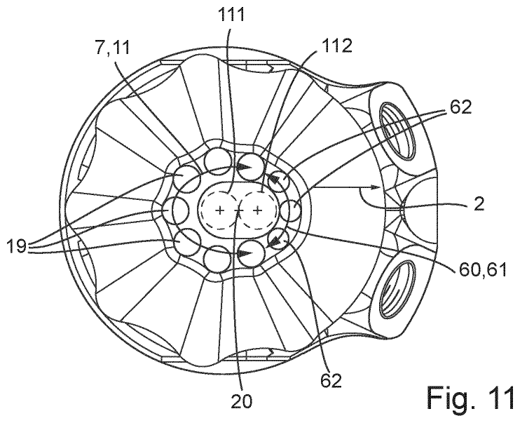

FIG. 11 shows the jet nozzle 1 in a top view of the distal region 8. The primary beam 111 and the secondary beam 112 are guided within the light channel 3. The secondary beam 112 is in front of the primary beam 111 in the feed direction 2 and does not interact with a powder caustic, as described in more detail in connection with FIG. 5. When the laser beams interact with the material surface and the jet of powder, a vapor plume can form between the jet nozzle 1 and the workpiece 100. If this is not contained, it can interact with at least one laser beam and/or the unprocessed and/or processed material surface in an undesirable manner. In the region which adjoins the powder portion 11, the feed portion 12 can therefore be designed as a process gas portion 61. This is formed by the process gas unit 60 being arranged radially outside the light channel 3, which directs the process gas onto the workpiece. The process gas portion 61 can prevent undesired spreading of the vapor plume and thus contribute to precise workpiece processing with a robust jet nozzle design. The process gas portion 61 can form at least one, in the present case three, outlet openings 62. The outlet openings 62 are formed on one end face of the jet nozzle 1. An additional injector for supplying the process gas without additional material can be inserted into the respective outlet opening 62. An inner diameter of the outlet opening 62 can be smaller than an inner diameter of the injector guides 19. The process gas portion 61 also prevents powder particles from adhering to the end face of the jet nozzle 1. In this respect, the process gas portion 61 also increases the service life of the jet nozzle 1. The process gas portion 61 and the powder portion 11 can be provided circumferentially around the elongated hole formed by the light channel 3. Thus, the primary beam 111 and the secondary beam 112 are completely within the beams composed of the jet of powder and the process gas jet.

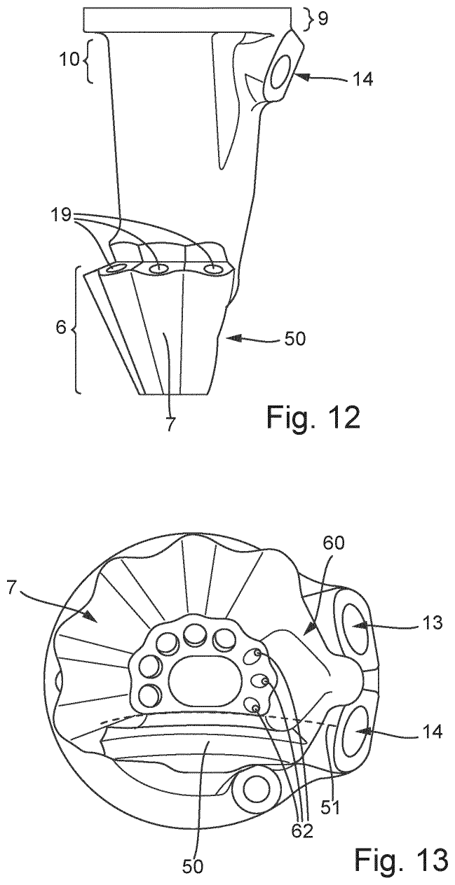

FIG. 12 shows a further embodiment of the jet nozzle 1. The nozzle mouth 6 has a chamfer 50, through which a part of the nozzle mouth 6 is cut off. The chamfer 50 has the effect that the powder portion 11 and the feed portion 12 without a powder portion are cut off in the circumferential direction around the light channel 3. The chamfer 50 reduces the volume of the nozzle mouth 6 compared to the embodiment in which there is no chamfer 50. This ensures that the nozzle mouth 6 takes up less installation space. The jet nozzle 1 with the chamfer 50 can be used, for example, to coat a brake disk. The brake disk can have a mount that protrudes axially from the functional surface to be coated. The chamfer 50 ensures that the jet nozzle 1 can move flexibly on the functional surface to be coated and can be moved close to the mount. The chamfer 50 can be substantially planar and run in a plane that is inclined relative to the longitudinal direction of the jet nozzle. The chamfer 50 represents a boundary surface of the nozzle mouth 6 in which a powder unit 7 is not provided. In the distal region 8, the chamfer 50 is arranged so close to the light channel 3 that no injector guides 19 are provided on an end face of the jet nozzle 1 facing the workpiece in the region of the chamfer 50.

FIG. 13 shows the jet nozzle 1 with the chamfer 50 in a top view. The chamfer 50 can run in the distal region 8 like a passant 51 on the elongated hole. The passant 51 defines the orientation of the chamfer 50 on the nozzle mouth 6. In the end face of the jet nozzle 1 facing the workpiece, the passant 51 runs along a straight line or an arc that neither intersects nor touches the elongated hole. The distance of the passant 51 from the center point 20 of the light channel 3 is greater than the distance of the corresponding portion of the elongated hole from the center point 20 of the light channel 3. The distance between the passant 51 and an outer edge of the elongated hole is selected in such a way that the wall thickness therebetween ensures sufficient sturdiness and load capacity of the jet nozzle 1.

The orientation of the passant 51 and thus the orientation of the chamfer 50 at the nozzle mouth 6 can be varied for different jet nozzles 1 depending on the respective application. For example, the passant 51 can run in the feed direction 2. In this case, the passant 51 runs along the extension of the cross-sectional area of the light channel 3. The passant 51 thus runs along the long side of the elongated hole. Alternatively, the passant 51 can run transversely to the feed direction 2, for example. In this case, the passant 51 runs transversely to the extension of the cross-sectional area of the light channel 3. The passant 51 thus runs along the partial circular section of the elongated hole. Further alternatively, the passant 51 can, for example, run at an angle to the feed direction 2 that lies between a course along the feed direction 2 and transverse to the feed direction 2. In this case, the passant 51 runs along the transition section between the long side of the elongated hole and the partial circular section of the elongated hole. The course of the passant 51 determines the orientation of the chamfer 50.

In the embodiment in FIG. 13, outlet openings 62 are provided on the front side of the jet nozzle. The process gas exits the process gas unit 60 from these outlet openings. In the present case, the chamfer 50 is such that the portion of the nozzle mouth 6 cut off by it originates entirely from the powder portion 11, so that the angle along which the powder portion 11 extends is reduced by the chamfer 50, while the angle along which the process gas unit 60 extends remains substantially the same.

Insofar as applicable, all individual features presented in the exemplary embodiments can be combined with one another and/or interchanged

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Jet nozzle
2 Feed direction
3 Light channel
4 Lateral surface
5 Outer structure
6 Nozzle mouth
7 Powder unit
8 Distal region
9 Flange portion
10 Proximal region
11 Powder portion
12 Feed portion
13 Coolant inlet
14 Coolant outlet
15 Coupling ring
16 Powder injector
17 Inlet connection
18 Outlet connection
19 Injector guide
20 Center point of the light channel
21 First powder focus
30 Cooling system
31 Radially inner cooling chamber
32 Transition
33 Radially outer cooling chamber
34 Honeycomb structure
35 Pin structure
50 Chamfer
51 Passant
60 Process gas unit
61 Process gas portion
62 Outlet opening
100 Workpiece
110 Laser beam
111 Primary beam
112 Secondary beam
120 Powdered filler material
130 Weld pool
140 Functional layer

1. A jet nozzle for laser deposition welding along a feed direction, the jet nozzle comprising
a light channel for guiding at least one laser beam, which is directed onto a workpiece; and
an outer structure, which surrounds the light channel at least in sections and extends from a flange portion to a distal region, which is formed by a nozzle mouth and from which the laser beam emerges;
wherein the outer structure comprises a cooling system, which has a radially inner cooling chamber at least in sections and a radially outer cooling chamber at least in sections, through which a coolant flows.

2. The jet nozzle according to claim 1, wherein
the radially outer cooling chamber extends from the distal region to a proximal region which adjoins the flange portion.

3. The jet nozzle according to claim 1, wherein
the radially inner cooling chamber is formed at least in the nozzle mouth and extends from the distal region to a proximal region which adjoins the flange portion.

4. The jet nozzle according to claim 1, wherein
the radially inner cooling chamber runs concentrically to the light channel in a cross-sectional area orthogonal to a longitudinal direction of the jet nozzle.

5. The jet nozzle according to claim 1, wherein
the radially inner cooling chamber is a channel running in a circumferential direction at least in the distal region of the nozzle mouth.

6. The jet nozzle according to claim 1, wherein
the radially inner cooling chamber and/or the outer cooling chamber comprises a cooling structure for increasing the surface area.

7. The jet nozzle according to claim 6, wherein
the cooling structure is configured as a honeycomb structure, and/or as a pin structure, and/or in as a fin structure.

8. The jet nozzle according to claim 1, wherein
a transition is provided from the radially inner cooling chamber to the radially outer cooling chamber in the distal region.

9. The jet nozzle according to claim 8, further comprising:
in the outer structure, a powder unit arranged radially outside the light channel for guiding at least one powder jet which is to be applied to the workpiece, wherein the powder unit forms a powder portion at the nozzle mouth in a circumferential direction around the light channel, to which a feed portion that is free of the powder unit adjoins in the circumferential direction.

10. The jet nozzle according to claim 9, wherein
the transition is configured as a passage in the feed portion.

11. The jet nozzle according to claim 1, wherein
the radially inner cooling chamber is connected to a coolant inlet, and the radially outer cooling chamber is connected to a coolant outlet.

12. The jet nozzle according to claim 11, wherein
the coolant inlet and/or the coolant outlet protrude radially from the outer structure at least in sections.

13. The jet nozzle according to claim 1, wherein the jet nozzle is manufactured by an additive manufacturing process and comprises copper or a copper alloy.

14. The jet nozzle according to claim 1, wherein
the nozzle mouth comprises a chamfer, by which a part of the nozzle mouth is cut off, wherein the chamfer is substantially planar and runs in a plane which is inclined relative to a longitudinal direction of the jet nozzle.
